(19) United States
(12) Patent Application Publication
(10) Pub. No.: US 2024/0323260 A1
(43) Pub. Date: Sep. 26, 2024

(54) SYSTEMS AND METHODS FOR INTEGRATING A CLIENT-FACING APPLICATION WITHIN A THIRD-PARTY INTERACTIVE ENVIRONMENT

(71) Applicant: The Toronto-Dominion Bank, Toronto (CA)

(72) Inventors: Jordan Alfred Chuck Morrison, Toronto (CA); Eduardo Medeiros Cabral, Burlington (CA); Valentyna Vogman, Toronto (CA)

(21) Appl. No.: 18/124,800

(22) Filed: Mar. 22, 2023

(51) Int. Cl. H04L 67/306; G06F 3/04815; H04L 67/50; H04L 67/55

(52) U.S. Cl. CPC H04L 67/306; G06F 3/04815; H04L 67/535; H04L 67/55

(57) ABSTRACT

Client-facing applications within third-party interactive environments are limited in how they process and present information. Systems, apparatus and methods are provided for integrating a client-facing application into a third-party interactive environment. A platform server hosts the interactive environment and the application within the interactive environment, which can be displayed on a client device. The platform server receives updates to the application state from the client device. Account information about the user of the client device is sent from the platform server to an integration server. This account information is processed by the integration server to generate user data, which is sent to the platform server. The user data is processed by the platform server to generate a user update, which is used to update the application within the interactive environment.

### TECHNICAL FIELD

The disclosed exemplary embodiments relate to computer-implemented systems and methods for integrating an application with a third-party interactive environment.

### BACKGROUND

Traditionally, large enterprises have maintained their own computing and networking infrastructure. This infrastructure includes databases, some of which may be highly secure with access limited only to a group of trusted users, and other databases and systems that are accessible to more enterprise users, or even members of the public such as clients.

With the advent of the Internet and mobile devices, and the widespread usage thereof, many organizations have developed client-facing applications, such as websites and mobile apps, that are able to access the enterprise systems to retrieve and/or modify data managed by the enterprise systems.

At the same time, these client-facing applications have acquired additional functionality. In some cases, this additional functionality is able to synthesize information from the enterprise systems, and therefore present additional useful information to the client.

### SUMMARY

The following summary is intended to introduce the reader to various aspects of the detailed description, but not to define or delimit any invention.

In at least one broad aspect, there is provided a system for integrating an enterprise environment with a third-party environment, the system comprising: a platform server comprising a memory, a network interface, and a processor, the processor operably coupled to the memory and the network interface, the processor configured to at least: communicate an application state of an interactive environment to one or more client devices of the interactive environment; receive updates to the application state from the one or more client devices; and maintain the application state based on the updates; and an integration server comprising an integration server memory, an integration server network interface, and an integration server processor, the integration server processor operably coupled to the integration server memory and the integration server network interface, the integration server processor configured to at least: retrieve account information of one or more users of the one or more client devices from the platform server; process the account information to generate user data; transmit the user data to the platform server, wherein the processor of the platform server is further configured to at least: receive the user data; execute a user application to process the user data and generate a user update; and display the user update within the interactive environment.

In some cases, the integration server further comprises an enterprise database, and wherein the integration server processor is further configured to retrieve enterprise account information from the enterprise database, and wherein the user data is generated based additionally on the enterprise account information.

In some cases, the interactive environment is a three-dimensional graphical environment.

In some cases, the user application provides a two-dimensional graphical user interface within the interactive environment.

In some cases, the user update is displayed within the two-dimensional graphical user interface.

In some cases, the user update is displayed as a separate two-dimensional object within the three-dimensional graphical environment.

In some cases, the user update is displayed as a texture applied to a three-dimensional object in the three-dimensional graphical environment.

In some cases, the user update is displayed as a graphical user interface within the three-dimensional graphical environment, and the graphical user interface is responsive to one or more three-dimensional user gestures detected by the platform server.

In some cases, the user update is a real-time notification.

In some cases, the user update is an activity report.

In some cases, the integration server processor is further configured to at least: obtain context information about the interactive environment within which the application is operating; process the context information with the user data to generate contextual user data that is associated with the interactive environment; and transmit the contextual user data to the application. The processor of the platform server is configured to display the contextual user data within the interactive environment.

In some cases, the context information comprises at least one of an object, an activity, an entity, and a location, and the integration server processor is further configured to at least: process the context information to obtain an information category; and search the account information that is specific to the information category, wherein one or more results of the search is the contextual user data.

In at least another broad aspect, there is provided an integration server comprising: an integration server memory, an integration server network interface, and an integration server processor, the integration server processor operably coupled to the integration server memory and the integration server network interface; wherein the integration server network interface is configured to communicate with an application hosted within an interactive environment by a platform server; and the integration server processor is configured to at least: obtain account information of one or more users associated with the application, the account information obtainable from the platform server; process the account information to generate user data; and transmit the user data, the user data transmittable to the application and displayable within the interactive environment.

In some cases, the integration server processor is further configured to at least: obtain context information about the interactive environment within which the application is operating; process the context information with the user data to generate contextual user data that is associated with the interactive environment; and transmit the contextual user data, the contextual user data transmittable to the application and displayable within the interactive environment.

In some cases, the context information comprises at least one of an object, an activity, an entity, and a location, and the integration server processor is further configured to at least: process the context information to obtain an information category; and search the account information that is specific to the information category, wherein one or more results of the search is the contextual client data.

In some cases, contextual user data is a wish list item provided by a user associated with the account information.

In some cases, the contextual user data comprises historical activity information of one or more activities conducted within the interactive environment.

In some cases, the integration server further comprises an enterprise database, and wherein the integration server processor is further configured to retrieve enterprise account information from the enterprise database, and wherein the user data is generated based additionally on the enterprise account information.

In some cases, the enterprise database comprises historical activity information specific to the interactive environment, and the user data comprises the historical activity information.

In at least another broad aspect, a method is provided for integrating an enterprise environment with a third-party environment, the method comprising: a platform server communicating an application state of an interactive environment to one or more client devices of the interactive environment; the platform server receiving updates to the application state from the one or more client devices; and the platform server maintaining the application state based on the updates; an integration server retrieving account information of the one or more users of the one or more client devices from the platform server; the integration server processing the account information to generate user data; the integration server transmitting the user data to the platform server; the platform server receiving the user data; the platform server executing a user application to process the user data and generate a user update; and the platform server displaying the user update within the interactive environment.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1A is a schematic diagram illustrating a platform server, an integration server and client devices interacting with each other in accordance with at least some example embodiments;

FIG. 1B is a schematic drawing of an example graphical rendering of an interactive environment displayed on a client device in accordance with at least some embodiments;

FIG. 2 is a block diagram illustrating an example computing system;

FIG. 3A is a block diagram illustrating data components of an interactive environment in accordance with at least some example embodiments;

FIG. 3B is a block diagram illustrating data components in an enterprise database in accordance with at least some example embodiments;

FIG. 4 is a flowchart diagram of an example method of integrating an application in an interactive environment provided by a platform server in accordance with at least some embodiments;

FIG. 5 is a flowchart diagram of an example method of processing context information about an interactive environment in accordance with at least some embodiments;

FIG. 6 is a flowchart diagram of an example method of processing context information using an information category in accordance with at least some embodiments;

FIG. 7 is a schematic drawing of an example graphical user interface that includes a floating application widget in an interactive environment, in accordance with at least some embodiments;

FIG. 8 is a schematic drawing of an example graphical user interface that includes a textured application widget in an interactive environment, in accordance with at least some embodiments;

FIG. 9 is a schematic drawing of an example graphical user interface that includes a notification application widget in an interactive environment, in accordance with at least some embodiments;

FIG. 10 is a schematic drawing of another example graphical user interface that includes a notification application widget in an interactive environment, in accordance with at least some embodiments; and

FIG. 11 is a schematic block diagram of an enterprise database system in accordance with at least some embodiments.

### DETAILED DESCRIPTION

To date, conventional client-facing applications, also herein referred to as user applications, have been offered in environments that are within the control of the enterprise. For example, web-based applications are provided by servers within the enterprise's control. Mobile applications are developed and published by the enterprise or their delegates. Accordingly, while some communication may take place over the public Internet, the end-user experience is controlled by the enterprise. Due to this approach, the information available to the end-user is also typically limited to information within the enterprise's stewardship.

The systems and methods described herein are for integrating client-facing applications, or applets, into third-party platforms that are not within an enterprise's control. The integrated client-facing applications may be configured to output display information within another graphical environment. In one example, the graphical environment is a metaverse environment.

The described systems generally may include a server operated by the enterprise, which can be configured by the user to have access to the user's accounts (or wallets) on one or more third-party platforms. Once configured, the integration server can periodically poll the third-party platforms for transaction updates, or be pushed updates by the third-party platforms, if available.

For each third-party platform, a client-facing application is provided, which can be installed or activated by each user. In one example embodiment, the client-facing application only retrieves information from its native platform. In other example embodiments, the client-facing application may retrieve information from the integration server, or the native platform, or both.

The client-facing application may be tailored to the needs of the provider. For example, an enterprise may develop client-facing applications for their employees to be able to access enterprise data, such as secure databases that host sensitive data. In another example, financial institutions may develop client-facing applications for their clients to be able to access their financial accounts and to perform certain tasks, such as paying bills. The applications of both examples may offer additional functionality, such as reports and insights based on sensitive data, transaction predictions, wish lists, and real-time activity notifications.

As noted, in some example embodiments, the described systems and methods provide for integrating with accounts of a third-party platform. For example, in a metaverse environment, the integration server may connect to an Application Programming Interface (API) or a digital wallet of a metaverse environment operated on a third-party platform, to retrieve relevant data (e.g., transactions or token balances) for integration with and display to the user together with the enterprise information.

In an example embodiment, an application display, also called a graphical user interface (GUI), shows an insights meter that can analyze transaction history and transaction categories, to provide insights into user activities across multiple platforms. In another example aspect, this insights meter presents insights based on information maintained by the enterprise or information retrieved from the third-party platform (e.g., via API or wallet), or both. In another example aspect, the information includes overall transaction activity, or insights based on categories of transactions, as identified by the described systems and methods.

In another example aspect, real-time notifications of enterprise activity or other activity from one or more third-party platforms are also be provided.

Still further displays can be provided to display additional information, such as wish lists. In an example aspect, these wish lists are based on enterprise information, or information from the one or more third-party platforms.

In an example embodiment, each of the displays is provided within a user interface element of the client-facing application. In an alternative example embodiment, certain displays are provided in user interface elements provided outside of the client-facing application, for example as pop-up displays, or even as textures applied to objects within the environment of the third-party platform.

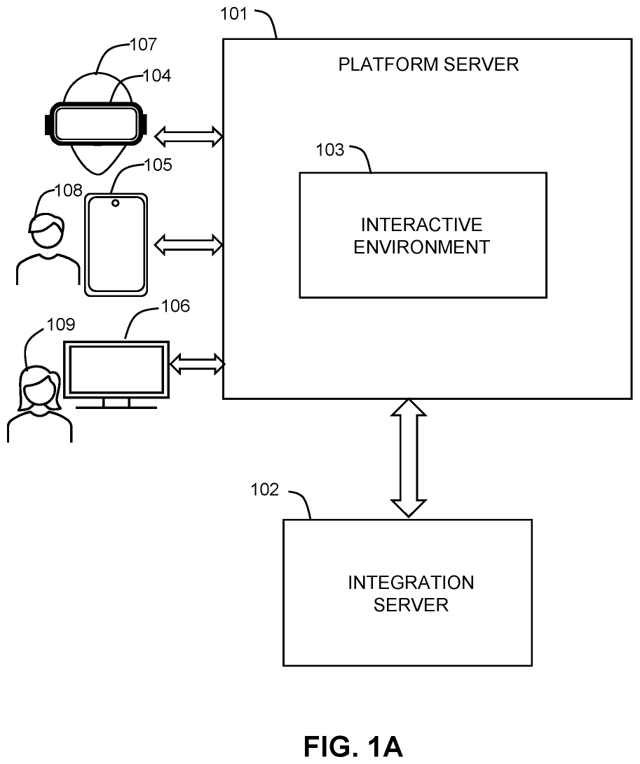

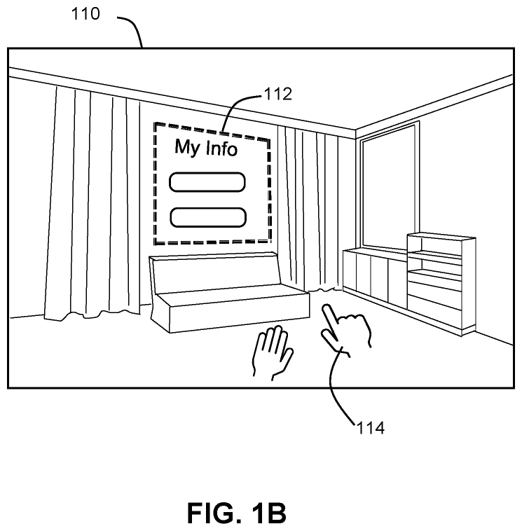

Referring now to FIG. 1A, an example of a platform server 101 is shown in data communication with an integration server 102 and with one or more client devices 104, 105, 106. Users 107, 108 and 109 respectively use the client devices 104, 105 and 106. The platform server 101 maintains and provides an interactive environment 103. In some example embodiments, data about the interactive environment 103 is transmitted to the client devices, the interactive environment is graphically rendered on the client devices, and the interactive environment enables users to use their client devices to interact with the interactive environment. The interactive environment is a digital visual environment that may be stateful or stateless, and can be rendered as 2D imagery or 3D imagery, or a combination of both. In an example aspect, a stateful interactive environment recalls saved information about previous sessions in the interactive environment. In an example aspect, a stateless interactive environment does not save or reference information about previous sessions in the interactive environment. In another example embodiment, the interactive environment is graphically rendered on the platform server and image data is transmitted to the client devices for display on the client devices. It will be appreciated that different processes for displaying the interactive environment on a given client device can be used.

An example illustration of the interactive environment 103 that has been graphically rendered is shown in FIG. 1B. The graphically rendered interactive environment 110 includes a client-facing application's graphical user interface (GUI) 112. The GUI 112 can display information about the user. Examples of user information include the user's name, their activities, their past transactions, their interests, their contacts, etc. Using a pointer, a gesture, or a virtual hand 114, or the like, the user can interact with the GUI 112 and the interactive environment 110. In other words, while the user is within the interactive environment 110, which is displayed in this example as a digital rendering of a room with a couch, floor and walls, the user can also access the application via the application's GUI 112, which is integrated into the interactive environment 110.

Referring back to FIG. 1A, an example embodiment of a client device is a headset 104 that includes one or more displays positioned close to the eyes of the user and which can display the interactive environment. The headset 104 can be used to display digital imagery for immersive virtual reality or digital imagery for augmented reality, or both. Another example embodiment of a client device is a mobile device 105 that includes one or more displays for displaying the interactive environment. Another example embodiment of a client device is a display screen 106. In an example embodiment, the display screen 106 and related computing hardware can be standalone, such as in a laptop or a desktop computer. In another example embodiment, the display screen 106 and related computing hardware are integrated into another object, such as a vehicle or a furniture item. In another example embodiment, the client device includes a display projector that projects imagery of the interactive environment onto ancillary surfaces. It will be appreciated that other types of client devices that can communicate with the platform server and display an interactive environment are applicable to the principles described herein.

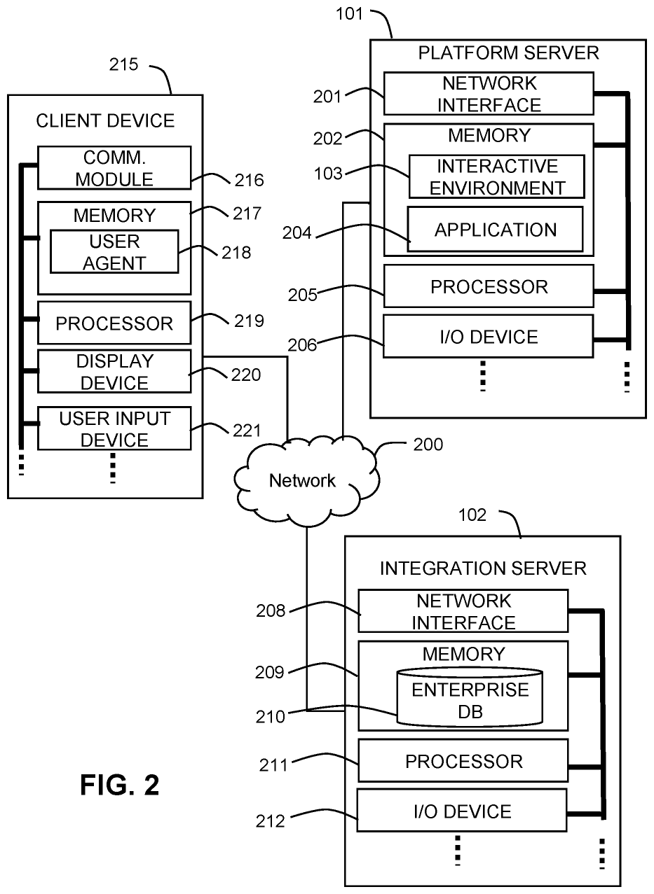

Referring now to FIG. 2, simplified block diagrams are illustrated of an example client device 215, an example platform server 101, and an example integration server 102 in accordance with at least some embodiments. The example implementation of the platform server 101 includes a network interface 201, a memory system 202 (also herein called “memory”), and a processor system 205 (also herein called “processor”) that are coupled together to facilitate data communication. An input/output device 206 may also be coupled to the processor 205.

Memory 202 includes a volatile memory that stores instructions executed or executable by processor 205, and input and output data used or generated during execution of the instructions. Memory 202 may also include non-volatile memory used to store input and/or output data along with program code containing executable instructions. It will be appreciated that memory may include one memory module or multiple memory modules coupled together.

Processor 205 is communicatively coupled to memory 202, may transmit or receive data via network interface 201, and may also transmit or receive data via any other input/output device 206 as appropriate. It will be appreciated that processor 205 may include one processor module or multiple processor modules coupled together.

Memory 202 also stores thereon an interactive environment 103. In an example embodiment, the interactive environment is a two-dimensional digital world or a three-dimensional digital world. The interactive environment maintains state information for the environment, including but not limited to different digital objects, digital widgets, digital avatars of users. This allows a user, through their client device, to connect to the interactive environment and cause their avatar or viewer to move about within the digital world and further interact with the digital objects, digital widgets, digital avatars of other users, or a combination thereof.

Memory 202 also stores thereon a client-facing application 204. The application 204 provides a GUI that integrates with and can be displayed within the interactive environment. For example, the client-facing application 204 may be a program such as a script or plug-in that is configured to execute within the interactive environment application. Accordingly, while the user is interacting with the interactive environment, the user can also view the GUI displayed by the application 204 integrated into the digital world, and interact with the application 204. For example, the GUI may be displayed as a texture in the digital world, or as a separate object within the digital world.

Although one application 204 is shown in the example illustration, it will be appreciated that in some cases there are multiple client-facing applications that can be integrated with the interactive environment. For example, a first application will perform a first set of executable actions and a second application will perform a second set of executable actions.

The example implementation of the integration server 102 includes a network interface 208, a memory system 209 (also herein called “memory”), and a processor system 211 (also herein called “processor”) that are coupled together to data communicate with each other. In an example aspect, an input/output device 212 is also coupled to the processor. The components of the integration server 102 are generally analogous to the components described in the platform server 101. Memory 209 includes an enterprise database 210 for storing enterprise data, including data about the user. Although the enterprise database 210 is illustrated as part of integration server 102, in other embodiments, the enterprise database 210 may be provided by one or more other servers, which may also be physically and logically segregated from integration server 102, and may have varying layers of access controls.

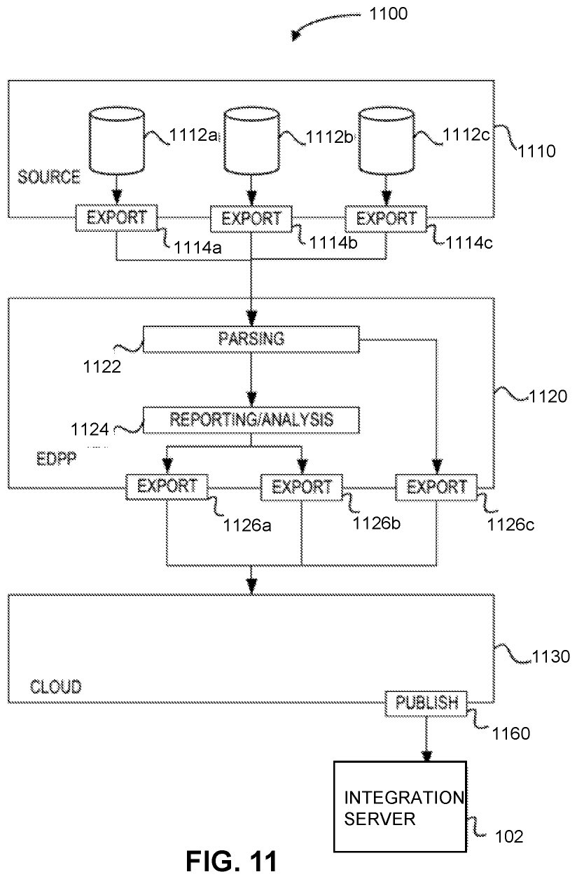

Referring briefly to FIG. 11, there is illustrated a block diagram of an example computing system with varying layers of access controls, in accordance with at least some embodiments. Computing system 1100 has a source database system 1110, an enterprise data provisioning platform (EDPP) 1120 operatively coupled to the source database system 1110, and a cloud-based computing cluster 1130 that is operatively coupled to the EDPP 1120.

Source database system 1110 has one or more databases, of which three are shown for illustrative purposes: database 1112a, database 1112b and database 1112c. Each of the databases of source database system 1110 may contain confidential information that is subject to restrictions on export. One or more export modules 1114 may periodically (e.g., daily, weekly, monthly, etc.) export data from the databases 1112 to EDP 1120. In some cases, the export data may be exported in the form of comma separated value (CSV) data, however other formats may also be used.

EDPP 1120, which may also be referred to as a publishing server, receives source data exported by the export modules 1114 of source database system 1110, processes it and exports the processed data to an application database within the cluster 1130. For example, a parsing module 1122 of EDPP 1120 may perform extract, transform and load (ETL) operations on the received source data.

In many environments, access to the EDPP may be restricted to relatively few users, such as administrative users. However, with appropriate access permissions, data relevant to an application or group of applications (e.g., a client application) may be exported via reporting and analysis module 1124 or an export module 1126. In particular, parsed data can then be processed and transmitted to the cloud-based computing cluster 1130 by a reporting and analysis module 1124. Alternatively, one or more export modules 1126 can export the parsed data to the cluster 1130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, such as the integration server or platform server described herein, or that are shared among multiple organizations, as is common in a cloud-based environment. In particular, such privacy restrictions may prohibit the confidential data from being transmitted to distributed or cloud-based computing systems, or the integration server or platform server, without appropriate anonymization or obfuscation of personal identifiable information in the confidential data. Moreover, such “on-premises” systems typically are designed with access controls to limit access to the data, and thus may not be resourced or otherwise suitable for use in broader dissemination of the data. To comply with such restrictions, one or more module of EDPP 1120 may “de-risk” data tables that contain confidential data prior to transmission to cluster 1130. This de-risking process may, for example, obfuscate or mask elements of confidential data, or may exclude certain elements, depending on the specific restrictions applicable to the confidential data.

Enterprise data, including data about the user, is published 1160 from the cluster 1130 to the integration server 102.

Referring back now to FIG. 2, an example block diagram of a client device 215 is provided, which can be used to implement the example client devices 104, 105, 106 or some other client device.

The client device 215 includes a communication module 216, a memory system 217 (also herein called “memory”), a processor system 219 (also herein called “processor”), a display device 220, and a user input device 221 that are coupled together for data communication.

The communication module 216 is configured to data communicate with the platform server via a network 200. In an example aspect, the network interfaces 201, 208 and the communication module 216 facilitate data communication using the network 200. In an example aspect, the network is a wireless data network, or a wired data network, or a combination thereof. For example, the network 200 can be the Internet.

Memory 217 in the client device stores thereon, amongst other things, a user agent 218 that facilitates accessing, interacting with, rendering and displaying the interactive environment 103. For example, the user agent can be a software application such as an Internet web browser or a dedicated application on the client device.

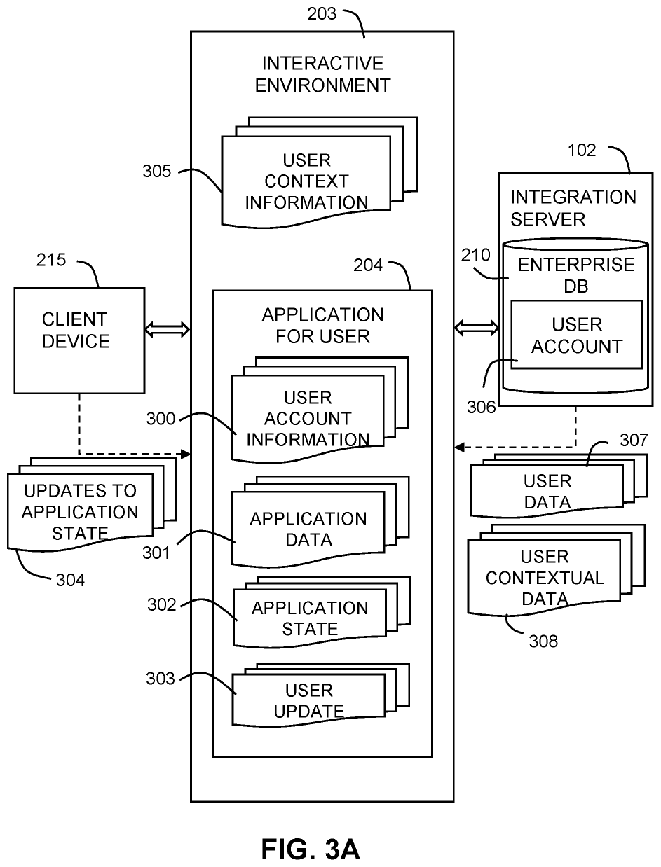

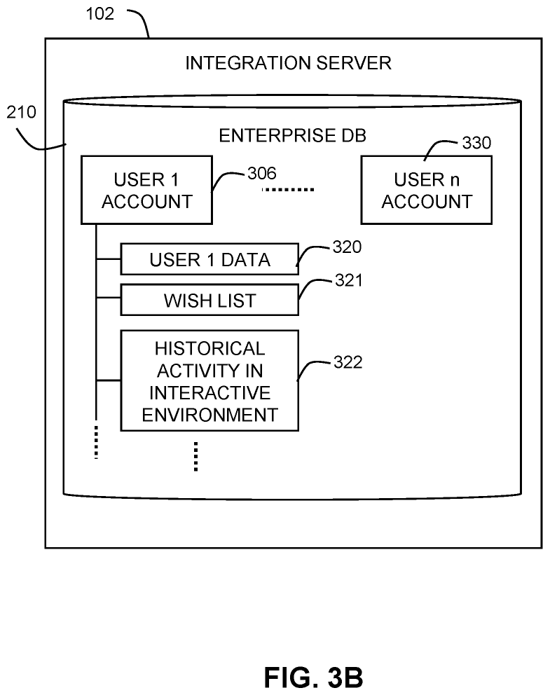

Referring now to FIG. 3A, the schematic diagram shows example data components in the interactive environment 103. Data generally is specific to a user. Although a client device 215 for a user is shown in FIG. 3A, in some other example embodiments, multiple users with their respective client devices can access an interactive environment and different users may have access to different data. In other words, in some cases, additional users and their user account information can exist within the same interactive environment 103, and the integration server 102 can interact with the interactive environment to process data for the additional users.

Continuing with FIG. 3A, the application 204 retrieves and/or processes client account information 300, application data 301, one or more application states 302, and one or more user updates 303. User account information 300 includes, for example, an identifier of the client account. Examples of identifiers include an identity code, a name, an email address, or a combination thereof. Other types of identifiers can be used. Application data 301 includes data specific to the application 204. It will be appreciated that different types of applications have different types of data. Examples of applications include communication applications, security applications, gaming applications, asset tracking applications, transaction applications, etc. and their respective types of data may vary between these different applications. An application state 302, for example, is an example of application data that is updatable by the user through their client device. User updates 303 include data received or generated by the application 204 that can change a previous application state to a new application state.

In an example embodiment, the platform server 101 transmits an application state 302 to the client device 215. The client device 215 provides updates to a state of the application 304, also called an application state update. After it is received and processed by the application 204, the application state update causes an update to the state of the application, resulting in a new current state of the application. For example, the user provides an input to the application while viewing the interactive environment, and the input results in a change to the application state. The user input, for example, initiates executable actions in the application, or is a change of a parameter in the application.

Non-limiting examples of updates to an application state include: executing a search, launching a report, launching an activity dashboard, executing a transaction, initiating a communication session with a contact, inputting text content or audio content or visual content or a combination thereof, and executing an activity.

The one or more updates to the application state are detected by the platform server, and the platform server in turn updates the application state to provide and maintain a new application state. In some cases, the new maintained application state may trigger or involve an update to the application's GUI within the interactive environment.

The integration server obtains account information 300 about the given user and uses it to obtain user data 307 about the given user. The user data, for example, includes a status of the given user, transactions associated with the given user, activities associated with the given user, permissions associated with the given user, contacts associated with the given user, and assets associated with the given user. The user data associated with the given user is sent to the application 204 on the platform server, and the application 204 processes the user data to generate a user update 303 that is viewable on the application GUI.

While the examples described and shown herein relate to visually depicting updates to an application state and user updates in the application, it will be appreciated that updates to an application state and user updates in the application can be implemented using one or more of: visual output, audio output and tactile output.

In an example aspect, the enterprise database 210 stores information about the given user in a given user account 306. The integration server, in some cases, searches data from the given user account 306 to obtain the user data 307.

In another example aspect, the application 204 operates in the context of the interactive environment and there is context information 305 about the interactive environment that is being viewed by the user. For example, a user is interacting with an interactive environment, and the context information includes one or more of a person, an object, an attribute, a place, a sentiment, a brand, a sound, and an activity that is visually outputted or audio outputted, or both, as part of the interactive environment. In some cases, the context information 305 is transmitted in association with the user account information 300 to the integration server 102. The integration server uses the context information to obtain contextual data 308 specific to the user client. For example, the contextual data is obtained by searching the enterprise database 210. The platform server, for example, processes the contextual data 308 to derive or generate a user update 303.

Referring now to FIG. 3B, a more detailed example block diagram is shown of data components in the enterprise database 210. As previously noted, the enterprise database 201 is depicted as part of integration server 102 for convenience, but in other implementations it may be provided by one or more other servers. An example of another implementation of an enterprise database was described with respect to FIG. 11. Referring back to FIG. 3B, the given user account 306 includes user data 320, a wish list 321 associated the user client, and historical activity of the user client in the interactive environment 322. Other types of data that may be stored about the given user include one or more of: assets data, contacts data, location data, preference data, etc.

Multiple user accounts 330 for different users can be stored in the enterprise database 210.

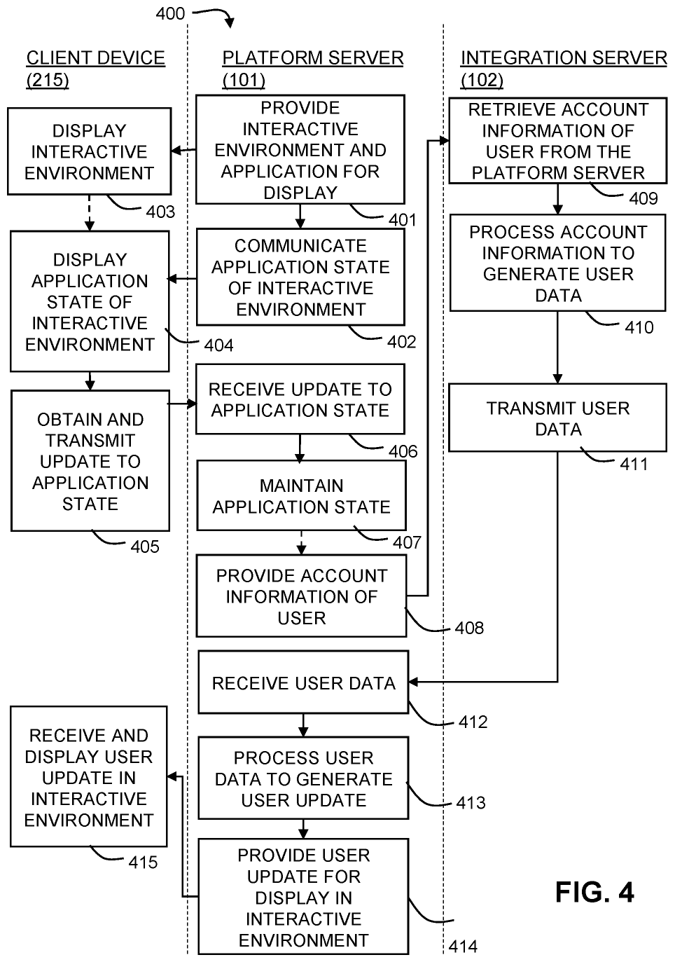

Referring now to FIG. 4, there is illustrated a flowchart diagram of an example method of integrating the application into the platform server, which in some cases is also herein considered a third-party environment. Method 400, which is in accordance with at least some embodiments, may be carried out, e.g., by a processor of a client device, a processor of the platform server, and a processor of the integration server. In another example, the flowchart is representative of processor executable instructions.

At 401, the platform server provides an interactive environment and an application for display on a client device. At 402, the platform server communicates an application state of the interactive environment to the client device using its network interface. In some example cases, this may include the processor and the memory of the platform server operating together to graphically render the interactive environment and the application within interactive environment. In some other example cases, the platform server transmits data about the interactive environment and data about the application, including the application state, to the client device, and the client device's processor locally visually renders the interactive environment and the application.

Responsive to 401 and/or 402, the client device displays the interactive environment and the application in its current state within the interactive environment at 403 and/or 404, respectively.

At 405, the client device obtains and transmits an update to the application state to the platform server. For example, after viewing the application in the interactive environment, the user of the client device provides an input that initiates a change or an update to the application state.

At 406, the platform server receives the update to the application state 406 and subsequently can maintain the application state at 407.

After receiving the update to the application state, or at some time prior to receiving the update to the application state, at 408, the platform server transmits account information of the user to the integration server.

After obtaining the account information of the user from the platform server at 409, the integration server uses its processor to retrieve (e.g., from an enterprise database) and/or process the account information to generate user data at 410. At 411, the integration server transmits the user data to the platform server, for example, using its network interface.

After receiving the user data at 412, the platform server uses its processor to process the user data and to generate one or more user updates at 413.

At 414, the platform server provides the one or more user updates for display in the interactive environment. For example, using the platform server's processor to visually render the user update in the application within the interactive environment and transmitting the new rendering to the client device using the platform server's network interface. Alternatively, the user update is sent to the client device, and the client device locally visually renders the user update within the interactive environment using the client device's processor.

At 415, the client device receives and displays the user update in the interactive environment.

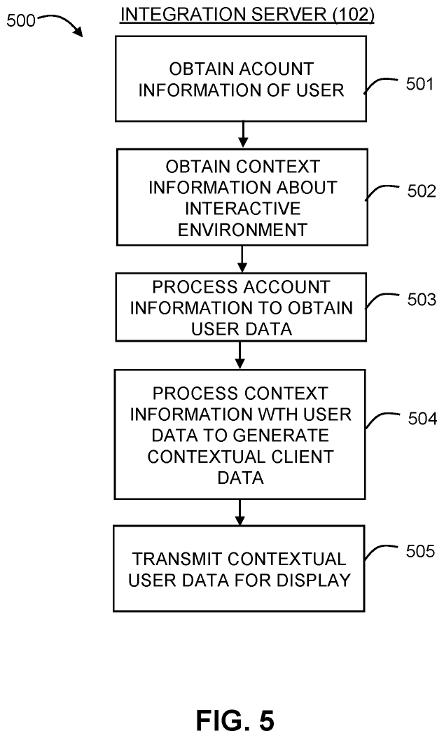

Referring now to FIG. 5, there is illustrated a flowchart diagram of an example method of integrating an application for a user in a third-party environment in accordance with at least some embodiments. Method 500 may be carried out, e.g., by a processor of an integration server 102. In another example, the flowchart is representative of processor executable instructions.

At 501, the integration server obtains account information of the user from, e.g., the client device. This is receivable, for example, via the integration server's network interface.

At 502, the integration server obtains context information about the interactive environment from, e.g., the platform server. This is receivable, for example, via the integration server's network interface.

At 503, the integration server uses its processor to process the account information to obtain user data. For example, the user data is obtained by searching an enterprise database and, particularly, seeking data associated with the account information of the user.

At 504, the integration server uses its processor to process the context information with the user data to generate contextual user data. For example, data that is associated with the context information and the client data is labeled or identified as contextual user data.

At 505, the integration server transmits the context user data. In an example aspect, the contextual user data is displayed in the application within the interactive environment.

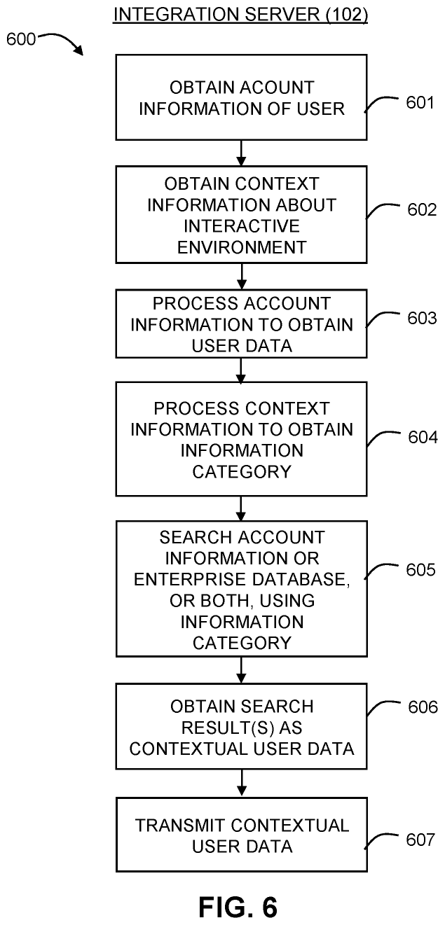

Referring now to FIG. 6, there is illustrated a flowchart diagram of another example method of integrating an application for a user in a third-party environment in accordance with at least some embodiments. Method 500 may be carried out, e.g., by a processor of an integration server 102. In another example, the flowchart is representative of processor executable instructions.

At 601, the integration server obtains account information of the user. At 602, the integration server obtains context information about the interactive environment. At 603, the integration server uses its processor to process the account information to obtain user data.

At 604, the integration server uses its processor to process the context information to obtain one or more information categories. For example, the context information includes at least one of an object, an activity, an entity (e.g., person, company, brand, etc.), an attribute, and a location. The context information is used to find an associated information category. For example, the context information includes a piano, which is an object, and the associated information category can be entertainment, or music, or wishlist. In another example, the context information includes a person, which is an entity, and the associated information category or categories can be one or more of: a friend, an activity associated with the person, and communications associated with the person. It will be appreciated that the mapping(s) between the context information and the one or more information categories can vary by type of application.

At 605, the integration server uses its processor to search the account information or the enterprise database, or both, using the one or more information categories.

At 606, the one or more search results are labeled or identified as contextual user data.

At 607, this contextual data is transmitted by integration server, via its network interface, to the platform server.

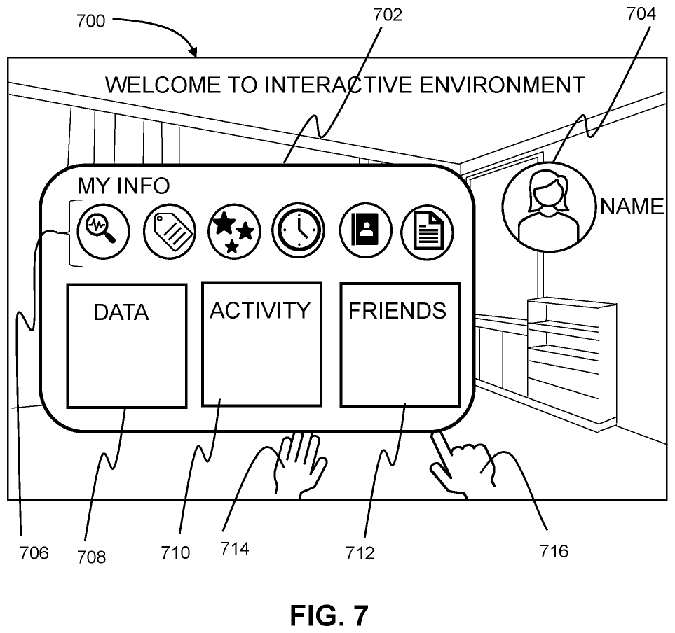

Referring now to FIG. 7, an example GUI 700 of an interactive environment is shown. The interactive environment, in this illustrated example, is a digital room that includes digital furniture. An application GUI 702 is positioned within the interactive environment, and is displayed as a floating digital widget. A client identity widget 704, which is part of the application GUI 702, shows a given user's image (e.g., their face) and their name. This interactive environment can be a two-dimensional or three dimensional. In an example aspect, the interactive environment is part of the metaverse and provides an immersive visual experience, and is displayable using a client device.

The application GUI 702 is specific to the given user. It includes their information. Examples include data 708, activities 710, and friends 712. The application GUI 702 also includes interactive controls 706 that initiate executable actions within the application. Pointers, virtual digital hands, or other types of visual control components 712 and 714 are also displayed in the interactive environment.

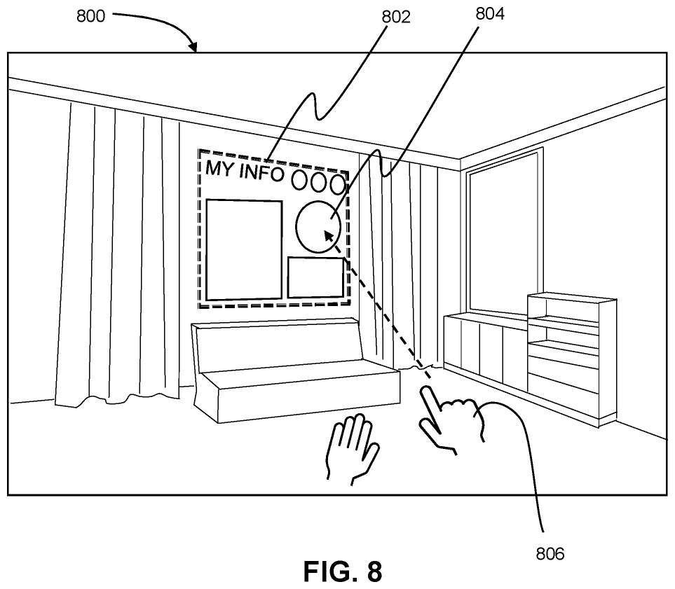

Referring now to FIG. 8, another example GUI 800 of an interactive environment is shown. An application GUI 802 is rendered as a texture layered on a three-dimensional surface, in this case a wall, within a three dimensional embodiment of an interactive environment. For example, the platform server renders the application GUI 802, which can be a 2D window, by applying perspective skewing to match the viewing perspective on the three-dimensional surface on which it is overlaid. Alternatively, the visual rendering is executed locally on the client device's processor, based on the instructions and data provided by the platform server.

The user pointer, or virtual hand 806, is controlled by the client device to interact with a user control 804 within the application GUI 802.

It will be appreciated that the controls, shapes, data, functions, and overall look of the application GUI within the interactive environment can vary, and the principles described herein are applicable to such variations.

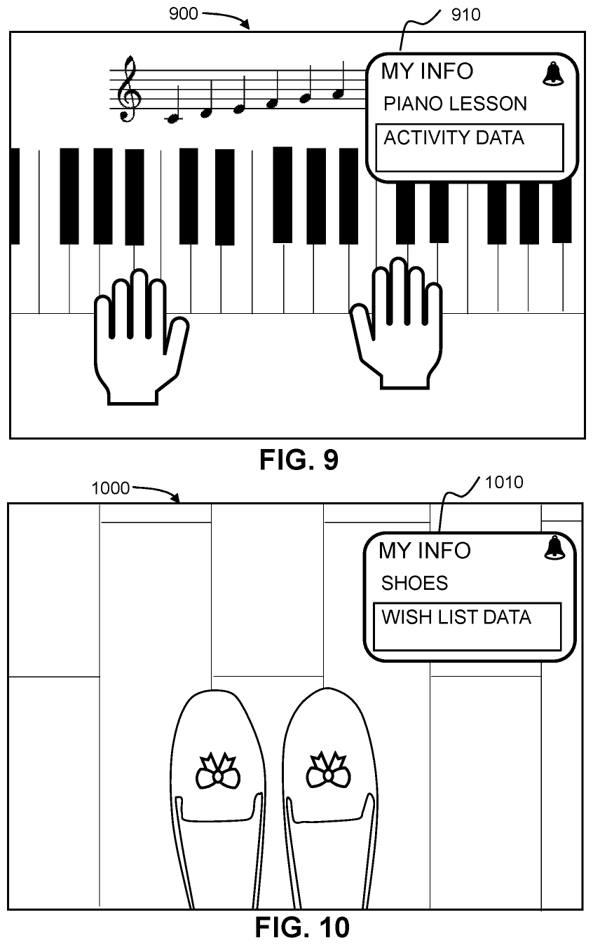

Referring now to FIG. 9, an example GUI 900 of an interactive environment is shown. The user is using their client device, for example, to play a virtual piano. The virtual piano playing is context information, which is processed by the integration server. This leads to identifying an information category, in this example, an activity category. In turn, the activity category is used to search and provide a contextual user data, which includes activity data about the given user. For example, contextual client data shown in FIG. 9 is implemented as a notification window 910 of the application, and it show activity data about the user, in this illustrated case, related to a piano lesson. In some cases, the notification window 910 is a pop-up notification that appears within the interactive environment, responsive to detecting contextual information.

Referring now to FIG. 10, another example GUI 900 of an interactive environment is shown. Shoes are shown within the interactive environment. These shoes are context information, which is processed by the integration server. The processing leads to identifying an information category, and in turn, obtaining contextual user data. In this example, the shoes are objects, which lead to identifying an information category called wish list. The wish list category is used to search for user data specific to the wish list category, resulting in contextual user data specific to the user and the wish list. In this illustrated case, the application's notification GUI 1010 includes the contextual user data showing wish list data specific to shoes. In an example aspect, the notification GUI 1010 is a real-time notification that pops up based on the current state of interactive environment. For example, responsive to detecting the shoes in real-time in the interactive environment, the notification GUI 1010 of the application pops up for the user to see and interact with.

In the embodiments of each of the above-noted examples, the GUI may be customized to each user device. Accordingly, the information shown in the GUI may be visible only to a user of the specific user device associated with a particular identifier. In other embodiments, however, the GUI or portions thereof may be visible to other users of the interactive environment.

It will be appreciated that many other types of interactive environments and application widgets can be used to show different types of information.

Various apparatuses or processes have been described to provide examples of embodiments of the claimed subject matter. No such example embodiment described limits any claim and any claim may cover processes or apparatuses that differ from those described. The claims are not limited to apparatuses or processes having all the features of any one apparatus or process described above or to features common to multiple or all the apparatuses or processes described above. It is possible that an apparatus or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112-1). All elements with a common base number may be referred to collectively or generically using the base number without a suffix (e.g., 112).

The systems, methods, and apparatus described herein may be implemented as a combination of hardware or software. In some cases, the systems, methods, and apparatus described herein may be implemented, at least in part, by using one or more computer programs, executing on one or more programmable devices including at least one processing element, and a data storage element (including volatile and non-volatile memory and/or storage elements). These apparatus may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems, methods and apparatus, including the platform server and the integration server, described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the processing systems, which can include central processing units (CPUs), the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems, apparatus and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or apparatuses, it will be appreciated that other processes or apparatuses may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A system for integrating an enterprise environment with a third-party environment, the system comprising:
a platform server comprising a memory, a network interface, and a processor, the processor operably coupled to the memory and the network interface, the processor configured to at least:
communicate an application state of an interactive environment to one or more client devices of the interactive environment;
receive updates to the application state from the one or more client devices; and
maintain the application state based on the updates; and
an integration server comprising an integration server memory, an integration server network interface, and an integration server processor, the integration server processor operably coupled to the integration server memory and the integration server network interface, the integration server processor configured to at least:
retrieve account information of one or more users of the one or more client devices from the platform server;
process the account information to generate user data;
transmit the user data to the platform server,
wherein the processor of the platform server is further configured to at least:
receive the user data;
execute a user application to process the user data and generate a user update; and
display the user update within the interactive environment.

2. The system of claim 1, wherein the integration server further comprises an enterprise database, and wherein the integration server processor is further configured to retrieve enterprise account information from the enterprise database, and wherein the user data is generated based additionally on the enterprise account information.

3. The system of claim 1, wherein the interactive environment is a three-dimensional graphical environment.

4. The system of claim 3, wherein the user application provides a two-dimensional graphical user interface within the interactive environment.

5. The system of claim 4, wherein the user update is displayed within the two-dimensional graphical user interface.

6. The system of claim 3, wherein the user update is displayed as a separate two-dimensional object within the three-dimensional graphical environment.

7. The system of claim 3, wherein the user update is displayed as a texture applied to a three-dimensional object in the three-dimensional graphical environment.

8. The system of claim 3, wherein the user update is displayed as a graphical user interface within the three-dimensional graphical environment, and the graphical user interface is responsive to one or more three-dimensional user gestures detected by the platform server.

9. The system of claim 1, wherein the user update is a real-time notification.

10. The system of claim 1, wherein the user update is an activity report.

11. The system of claim 1, wherein the integration server processor is further configured to at least:
obtain context information about the interactive environment within which the application is operating;
process the context information with the user data to generate contextual user data that is associated with the interactive environment; and
transmit the contextual user data to the application; and
the processor of the platform server is configured to display the contextual user data within the interactive environment.

12. The system of claim 11, wherein the context information comprises at least one of an object, an activity, an entity, and a location, and the integration server processor is further configured to at least:
process the context information to obtain an information category; and
search the account information that is specific to the information category, wherein one or more results of the search is the contextual user data.

13. An integration server comprising:
an integration server memory, an integration server network interface, and an integration server processor, the integration server processor operably coupled to the integration server memory and the integration server network interface;
wherein the integration server network interface is configured to communicate with an application hosted within an interactive environment by a platform server; and
the integration server processor is configured to at least:
obtain account information of one or more users associated with the application, the account information obtainable from the platform server;
process the account information to generate user data; and
transmit the user data, the user data transmittable to the application and displayable within the interactive environment.

14. The integration server of claim 13, wherein the integration server processor is further configured to at least:
obtain context information about the interactive environment within which the application is operating;
process the context information with the user data to generate contextual user data that is associated with the interactive environment; and
transmit the contextual user data, the contextual user data transmittable to the application and displayable within the interactive environment.

15. The integration server of claim 14, wherein the context information comprises at least one of an object, an activity, an entity, and a location, and the integration server processor is further configured to at least:
process the context information to obtain an information category; and
search the account information that is specific to the information category, wherein one or more results of the search is the contextual client data.

16. The integration server of claim 15, wherein the contextual user data is a wish list item provided by a user associated with the account information.

17. The integration server of claim 15, wherein the contextual user data comprises historical activity information of one or more activities conducted within the interactive environment.

18. The integration server of claim 13 further comprising an enterprise database, and wherein the integration server processor is further configured to retrieve enterprise account information from the enterprise database, and wherein the user data is generated based additionally on the enterprise account information.

19. The integration server of claim 18 wherein the enterprise database comprises historical activity information specific to the interactive environment, and the user data comprises the historical activity information.

20. A method for integrating an enterprise environment with a third-party environment, the method comprising:
a platform server communicating an application state of an interactive environment to one or more client devices of the interactive environment;
the platform server receiving updates to the application state from the one or more client devices; and
the platform server maintaining the application state based on the updates;
an integration server retrieving account information of one or more users of the one or more client devices from the platform server;
the integration server processing the account information to generate user data;
the integration server transmitting the user data to the platform server,
the platform server receiving the user data;
the platform server executing a user application to process the user data and generate a user update; and
the platform server displaying the user update within the interactive environment.
